(19) United States
(12) Patent Application Publication
(10) Pub. No.: US 2010/0307207 A1
(43) Pub. Date: Dec. 9, 2010

(54) ADJUSTABLE BACKSET LOCKSET

(75) Inventors: Christopher Edward Vogel, Knoxville, TN (US); John Steven Gray, Maryville, TN (US)

Correspondence Address: MOORE & VAN ALLEN PLLC, P.O. BOX 13706, Research Triangle Park, NC, 27709, US

(73) Assignee: YALE SECURITY INC., Monroe, NC (US)

(21) Appl. No.: 12/481,136

(22) Filed: Jun. 9, 2009

(51) Int. Cl. E05B 65/06; E05C 17/04; E05C 1/00

(52) U.S. Cl. 70/106; 292/262; 292/1.5

(57) ABSTRACT

A lock assembly including a latchbolt that may be effectively lengthened to accommodate varied backset distances for doors. The lock assembly may include a housing, a latchbolt including an attachment member, an extension member, a retractor element, and an operator. The extension member may be mounted to the attachment member to extend from the latchbolt for effective lengthening of the latchbolt. The retractor element, operatively responsive to the operator, is disposed within the housing for linear reciprocating movement to move the latchbolt, and is selectively engageable with the attachment member or with the extension member. The extension member defines a recess adapted to receive the attachment member. A latch case may receive the latchbolt, and a cylindrical sleeve may receive the latch case and the latchbolt when the extension member is in use to increase the backset dimension.

### BACKGROUND

Embodiments of an adjustable backset lockset described herein relate generally to a lockset for use with a door, and more particularly to a lockset with an adjustable backset distance for use with doors having different backset distances.

“Backset” is the distance between the edge of a door and the relatively transverse axis of rotation about which the latch operator moves for extending and retracting a latch bolt of a latch mechanism. Backset has been standardized by the industry. Standard backsets for commercial door openings are 2⅜ inches and 2¾ inches.

Manufacturers of latch constructions have satisfied the demand for latchsets having standard backset measurements by producing and marketing two different models of latch constructions. However, maintaining an inventory of assemblies and components for locksets having two different backsets is inefficient.

An alternative is providing adjustable latch mechanisms, which have become an accepted feature of tubular locksets. Unfortunately, adjustable latch mechanism solutions for this application have typically been of insufficient strength for a Grade 1 or Grade 2 commercial lockset capable of meeting ANSI standards for “cylindrical” locks.

For the foregoing reasons, there is a need for a new lockset which is easily adjusted for mounting on doors of differing backset distances. Such adjustment should be effected in a way that provides the assembly with inherent strength. Ideally, the new lockset construction would allow for relatively quick and easy selective adjustment between the two standard backset measurements.

### SUMMARY

In accordance with an embodiment of an adjustable backset lockset, a lock assembly is provided comprising a housing, a latchbolt including an attachment member, an extension member, a retractor element, and an operator. The extension member has a length and is removeably mountable to the attachment member for effective lengthening of the latchbolt. The retractor element is disposed within the housing for linear reciprocating movement and is selectively engageable with the attachment member or with the extension member for movement with the retractor element. The operator is operatively connected to the retractor element for facilitating selective reciprocation of the retractor element for moving the latchbolt between a latched position and an unlatched position.

In accordance with another embodiment of an adjustable backset lockset, a lock assembly is provided comprising a housing, a latchbolt including an attachment member, means for effective lengthening of the latchbolt, means for linear reciprocating movement disposed within the housing, and a means for facilitating selective reciprocation of the retractor element. The effective lengthening means is removeably engageable with the attachment member. The linear reciprocating movement means is selectively engageable with the attachment member or with the effective lengthening means for movement with the linear reciprocating movement means. The means for facilitating selective reciprocation of the retractor element is for moving the latchbolt between a latched position and an unlatched position.

In accordance with another embodiment of an adjustable backset lockset, an extension member for a latchbolt of a lock assembly is provided. The latchbolt includes an attachment member. The lock assembly includes a retractor element for linear reciprocating movement and engageable with the attachment member. The extension member includes a body and a tail piece. The body has a longitudinal axis, a first end, and a second end. The tail piece is mounted to the body and extends from the first end, and is dimensioned so as to function in place of the attachment member when engaging the retractor element. The body defines a recess adapted to receive the attachment member from the second end and to transfer force to the attachment member during linear movement of the extension member as urged by the retractor.

In accordance with another embodiment of an adjustable backset lockset, a latchbolt assembly comprises a latchbolt including a bolt tail and an extension member. The extension member is removeably mountable to the bolt tail for effectively lengthening the latchbolt.

In accordance with another embodiment of an adjustable backset lockset, a method of adjusting the backset distance of a lock assembly is provided. The method comprises providing a lock assembly having a housing, a latchbolt including an attachment member, a retractor element disposed within the housing for linear reciprocating movement, and an operator operatively connected to the retractor element for facilitating selective reciprocation of the retractor element for moving the latchbolt between a latched position and an unlatched position. An extension member is provided that is sized and shaped to be engageable with the attachment member and with the retractor element. The extension member is secured to the attachment member and the extension member is engaged with the retractor element for movement with the retractor element.

### BRIEF DESCRIPTION OF THE DRAWINGS

For a more complete understanding, reference should now be had to the embodiments shown in the accompanying drawings and described below. In the drawings:

FIG. 1 is an exploded perspective view of a lockset assembly according to one embodiment of an adjustable backset lockset.

FIG. 2 is a close-up perspective view of the chassis assembly shown in FIG. 1.

FIG. 3 is an exploded perspective view of the chassis assembly shown in FIG. 2.

FIG. 4 is a side view of one embodiment of a latch assembly as mounted to the chassis assembly shown in FIG. 2, shown in a partial sectional side view.

FIG. 5 is a perspective view of the latch assembly shown in FIG. 4.

FIG. 6 is a perspective view of one embodiment of an extension clip.

FIG. 7 is an exploded perspective view of the latch retractor and the latch assembly shown in FIG. 4, the extension clip shown in FIG. 6, and an embodiment of a sleeve.

FIG. 8 is a perspective view of the extension clip shown in FIG. 6 mounted to the latch assembly shown in FIG. 5.

FIG. 9 is a perspective view of the latch assembly and extension clip shown in FIG. 8 with the sleeve shown in FIG. 7.

FIG. 10 is a side view of the latch assembly, extension clip, and sleeve shown in FIG. 9 as mounted to the chassis assembly shown in FIG. 2, shown in a partial sectional side view.

FIG. 11 is a perspective view of the assembled lockset assembly shown in FIG. 1.

FIG. 12A is a plan view of a second embodiment of an extension clip mounting arrangement.

FIG. 12B is a side view of the extension clip and mounting arrangement shown in FIG. 12A.

FIG. 13A is a plan view of a third embodiment of an extension clip and mounting arrangement.

FIG. 13B is a side view of the extension clip and mounting arrangement shown in FIG. 13A.

FIG. 14A is a plan view of a fourth embodiment of an extension clip and mounting arrangement.

FIG. 14B is a side view of the extension clip and mounting arrangement shown in FIG. 14A.

### DESCRIPTION

The embodiments of an adjustable backset arrangement are for use in a conventional lockset such as, for example, the locksets described by U.S. Pat. No. 4,920,773 and U.S. Pat. No. 6,131,970, the contents of both of which are incorporated herein by reference. Moreover, it is understood that the overall construction of the lockset assembly is not critical and, for purposes of illustration, may be as described herein or in the above-referenced U.S. patents. Accordingly, although exemplary embodiments will be described in detail herein with respect to an adjustable backset function, detailed explanations of the functioning of all of the lockset components are deemed unnecessary for understanding by one of ordinary skill in the art.

Certain terminology is used herein for convenience only and is not to be taken as a limitation. For example, words such as “upper,” “lower,” “left,” “right,” “horizontal,” “vertical,” “upward,” and “downward” merely describe the configuration shown in the figures. Indeed, the components may be oriented in any direction and the terminology, therefore, should be understood as encompassing such variations unless specified otherwise.

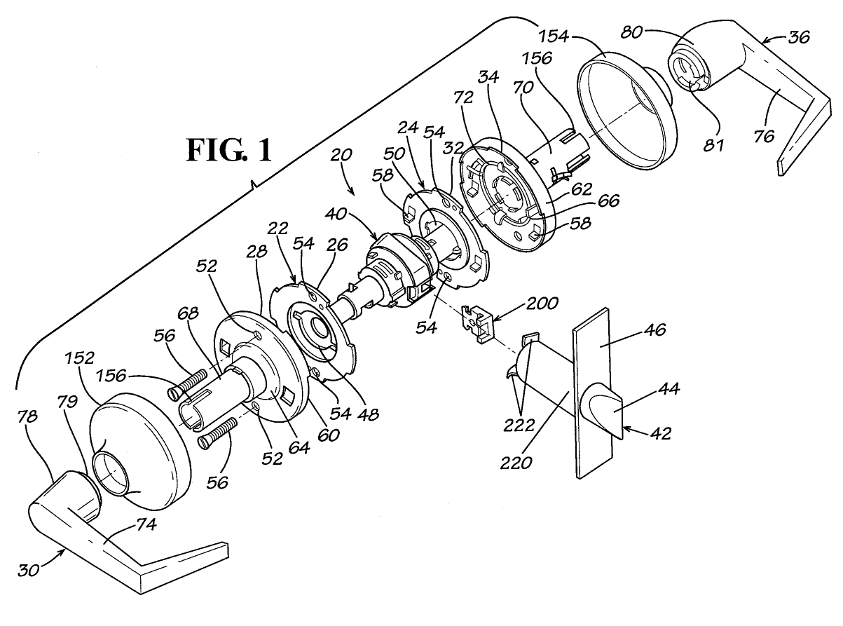

Referring now to the drawings, wherein like reference numerals designate corresponding or similar elements throughout the several views, a cylindrical lockset assembly for use with a conventional opening in a door (not shown) is shown in FIG. 1 and generally designated at 20. The cylindrical lockset assembly 20 comprises an inside subassembly 22 and an outside subassembly 24. The inside subassembly 22 includes a rose plate 26, a rose 28, and a lever 30. The outside subassembly 24 includes a rose plate 32, a rose 34, and a lever 36. A chassis 40 is located between the inside subassembly 22 and the outside subassembly 24. A latch assembly 42 is positioned for operable attachment to the chassis 40 and includes a latchbolt 44 that extends outwardly from a face plate 46 in an extended, or latched, position.

The rose plates 26, 32 are each formed in a generally circular configuration and having an axial central opening 48, 50. Two pair of holes 52, 54 are formed on the periphery of each rose plate 26, 32. One pair of holes 52 is adapted to pass bolts 56 which extend through the door. The other pair of holes is provided for receiving screws (not shown) for fastening the rose plates 26, 32 to their respective roses 28, 34. A pair of inwardly extending tabs 58 is formed in the outside rose plate 32 by punching holes through the outside rose plate 32.

The roses 28, 34 are each formed in a generally circular configuration and include a side wall 60, 62 defining an inner dish-like cavity in the inside surface of the rose 28, 34. An axial opening 64, 66 is formed through each rose 28, 34 and extends through rotating spindles 68, 70 which extend outwardly from the roses. A return spring 72 is positioned in the cavity of each rose 28, 34. As described above, the rose plates 26, 32 are fastened to the roses 28, 34 using screws for retaining the springs 72 within the cavity.

The levers 30, 36 each include a handle 74, 76 which is formed integrally with a hub 78, 80. Each hub 78, 80 has an axial opening 81 which, in a locking lockset, may communicate with an axial opening formed through the handle for receiving a turn button or lock cylinder for locking of the latchbolt in the extended, or latched, position. Further, although levers are shown, it is understood that other latch operating means are suitable, such as a doorknob or the like.

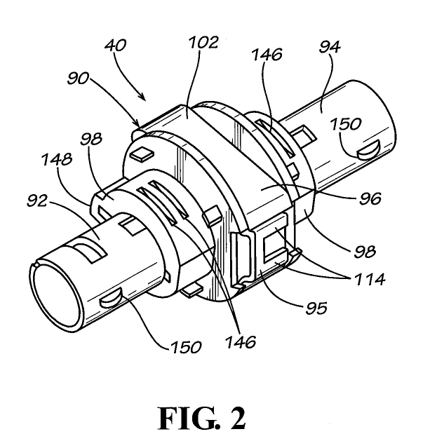

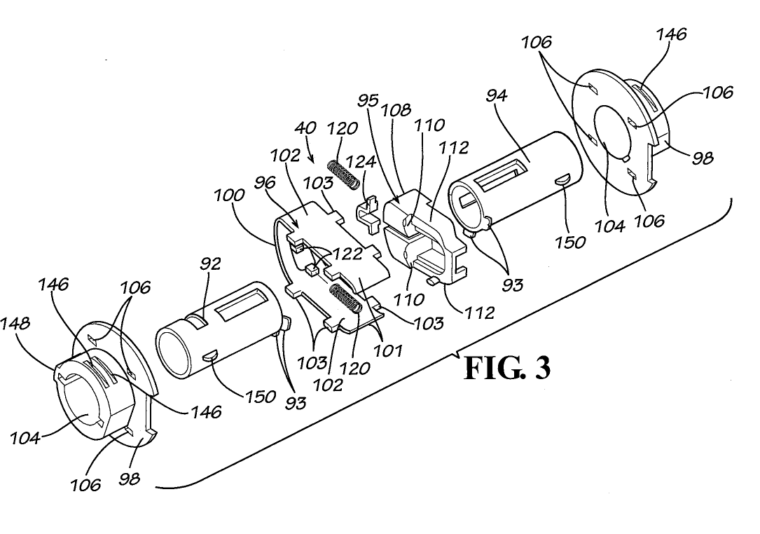

Referring now to FIGS. 2 and 3, the chassis 40 comprises a housing 90 for accommodating a U-shaped retractor 95 and opposed rollback sleeves 92, 94. The housing 90 includes a case 96 and opposed end caps 98. The case 96 is formed in a U-shaped configuration having a base 100 and a pair of legs 102 formed integrally with the base 100. The legs 102 have inwardly bent ends 101. Two pairs of opposed tabs 103 extend transversely from each leg 102.

The end caps 98 are generally circular and have a central axial opening 104. Four spaced notches 106 are formed in the end caps 98 for receiving the tabs 103 on the case 96.

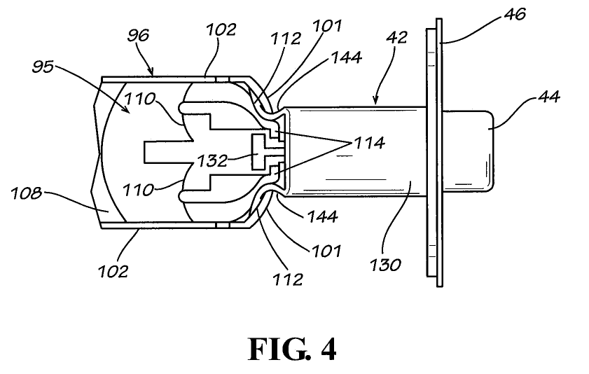

The retractor 95 is formed with a base 108 having a cam surface 110 on each side and a pair of spaced, parallel arms 112. The ends of the arms 112 are formed with a pair of opposed outer lips 114, shown in FIG. 4.

The sleeves 92, 94 are each formed with a pair of camming elements 93 at one end as shown in FIG. 3. The camming elements 93 are formed by rolling back portions of the sleeves 92, 94 which extend from the end of the cylindrical portions. The sleeves 92, 94 are rotatably received in the openings 104 in the end caps 98 as shown in FIGS. 2 and 3.

In assembling the components of the chassis 40, the rollback sleeves 92, 94 are positioned so that the camming elements 93 are located adjacent the cam surfaces 110 on each side of the retractor 95. The sleeves 92, 94 and retractor 95 are then located in the case 96 between the legs 102 and close to the inner surface of the base 100. The ends of two springs 120 are positioned over a pair of spaced posts 122 extending outwardly from the base 100 of the case 96. The other ends of the springs 120 engage a retainer 124, which fits in a corresponding opening in the rear of the retractor 95 thereby placing the springs 120 in a contained position for subsequent compression. To complete the housing 90, the end caps 98 are then slipped over the sleeves 92, 94 with the tabs 103 on the case 96 being inserted in the notches 106 in the end caps 98 and twisted. The retractor 95, the inward ends of the sleeves 92, 94, the springs 120 and the retainer 124 are contained within the housing 90. The sleeves 92, 94 extend outwardly from the openings 104 in the end caps 98. In this arrangement, the lips 114 of the retractor 95 are exposed through the housing 90.

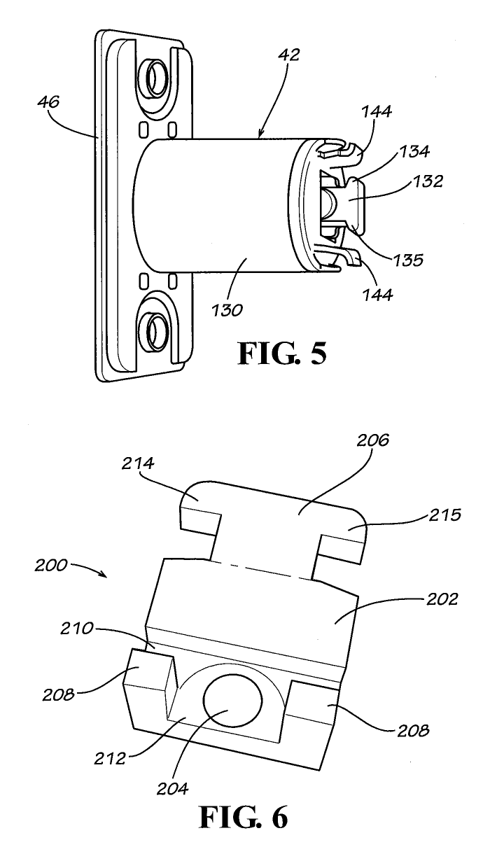

Referring now to FIG. 4, the latch assembly 42 includes the latch bolt 44, the face plate 46, and a latch case 130. The latch case 130 is secured at one end to the face plate 46. The latchbolt 44 is contained partially within the latch case 130 and extends outwardly of the latch case to the extended position through an opening in the face plate 46. The latchbolt 44 is retractable into the latch case 130 to a retracted, or unlatched, position. Thus, the latchbolt 44 is movable between the extended or latched position and the retracted or unlatched position. The latch bolt 44 includes a bolt tail 132 which extends from the rear of the latch case 130. The end of the bolt tail 132 is T-shaped and has arms 134, 135, as seen in FIG. 5. The bolt tail 132 is designed to be positioned through the opening of the retractor housing 90 with the arms 134, 135 located behind the lips 114 of the retractor 95. As shown in FIG. 4, the bolt tail 132 is adapted to be of a length to allow the arms 134, 135 to engage behind the lips 114 of the retractor 95. In this arrangement, upon rotation of one of the sleeves 92, 94, the camming elements 93 (FIG. 3) will engage the cam surfaces 110 on the retractor 95 to urge the retractor 95 inwardly against the biasing of the springs 120. As the retractor 95 is moved inwardly, the bolt tail 132 is pulled with the retractor 95 to withdraw the latchbolt 44 to the retracted position.

An embodiment of a tail extension clip 200 is shown in FIG. 6. The tail extension clip 200 includes a base 202, a magnet 204 recessed into the base, a clip tail piece 206, and a pair of protruding fingers 208. A channel 210 together with an opening 212 that is formed between protruding fingers 208 define a recessed area that is substantially the shape of a “T.” The channel 210 and opening 212 are sized to receive the bolt tail 132 and arms 134, 135, which may be a standard size, and as previously noted are also substantially T-shaped. The clip tail piece 206 includes arms 214, 215 that also substantially form a T-shape and result in the clip tail piece 206 being a functional substitute for the bolt tail 132 with respect to connection with the retractor 95, as discussed further below.

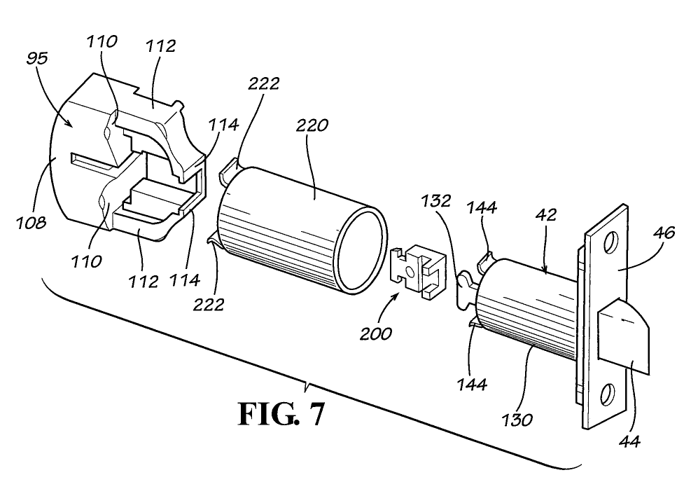

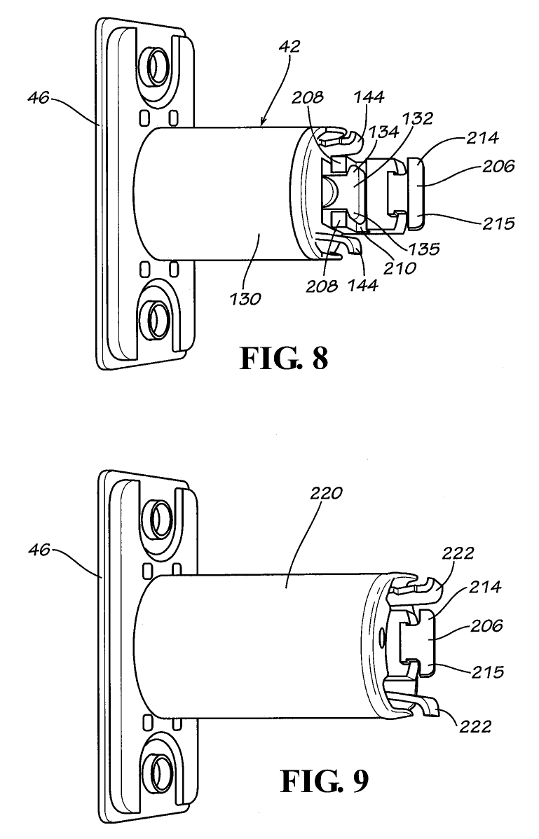

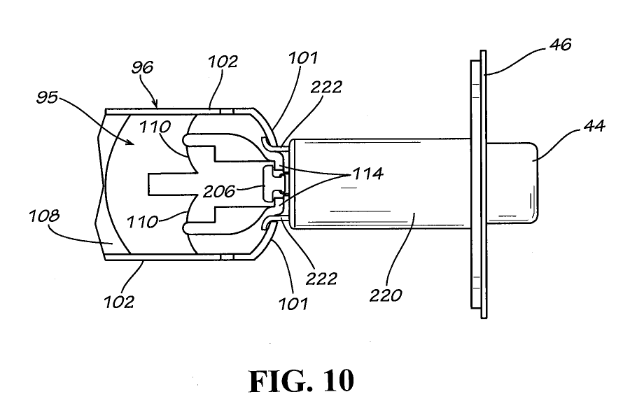

The extension clip 200 may be attached to the bolt tail 132 when the backset dimension is to be increased. The extension clip 200 extends from the bolt tail, effectively lengthening the latchbolt 44. Such an increase may be, for example, from 2⅜ to 2¾, which as previously discussed are standard dimensions of backsets. To accomplish this, in one embodiment the extension clip 200 is placed adjacent to the bolt tail 132, as shown in FIG. 7. The channel 210 receives the bolt tail 132 and the protruding fingers 208 slide underneath the arms 134, 135 to prevent movement of the bolt tail 132 longitudinally along the axis of the latchbolt 44 when the bolt tail 132 is attached to the clip 200. The extension clip 200 is sized and shaped to magnetically attach to one side of the bolt tail 132 by means of the magnet 204 embedded into the base 202. An auxiliary latch case, or sleeve 220, is passed over the latch assembly 42, as shown in FIG. 8, effectively lengthening the latch case 130. The sleeve 220 has a diameter sized to allow the bolt tail 132, extension clip 200, and latch case 130 to fit within the interior of the sleeve 220. The sleeve 220 has a pair of sleeve ears 222. The sleeve ears 222 engage the chassis 40 to secure the latch assembly 42 to the chassis (FIG. 10).

The addition of the extension clip 200 and the sleeve 220 increases the backset dimension. As assembled, in one embodiment the length of the tail extension clip 200 beyond the existing bolt tail is ⅜ inch. This is to accommodate the ⅜ inch difference between the standard backset dimension. Additionally, the sleeve 220 is a length that accommodates the additional length of the extension clip 200. These dimensions may enable the user to alter the backset dimension from 2⅜ inches to 2¾ inches easily and quickly. It should be understood that in the event the cylindrical lock assembly 20, installed on a door with a 2¾ backset, were to be used on another door where the backset dimension was 2⅜ inches, the assembly may be removed from the door and reassembled without the extension clip 200 and sleeve 220 to accommodate the smaller backset dimension of 2⅜ inches.

In assembling the components of the cylindrical lockset assembly 20 of FIG. 1 for a relatively short backset dimension as shown in FIGS. 4 and 5, such as 2⅜ inch, the latch assembly 42 is first positioned within an opening in the edge of a door. The edge opening communicates with a larger transverse opening in the door. The chassis 40 is inserted through the larger opening. As the chassis 40 is moved into the larger opening, the chassis 40 engages and becomes attached to the sleeve ears 144 extending from the rear of the latch case 130. The sleeve ears 144 fit behind the bent ends 101 of the legs 102 of the case 96. In this position, the housing 90 is located within the door opening and the sleeves 92, 94 extend from opposite sides of the door. The bolt tail 132 is then attached to the lips 114 of the retractor 95 in the manner previously described and the face plate 96 is secured to the edge of the door.

Alternatively, to assemble the components of the cylindrical lockset assembly 20 for a relatively long backset dimension as shown in FIGS. 7-10, such as 2¾ inch, the extension clip 200 is mounted to the bolt tail 132 and the sleeve 220 is then slipped over the original latch case 130. The sleeve 220 is longer than the latch case 130, but the bolt tail 132 and extension clip 200 are dimensioned so that the clip tail piece 204 extends from the rear of the sleeve 220. The modified latch assembly may then be connected to the chassis 40 by engaging the ears 222 extending from the rear of the sleeve 220 behind the bent ends 101 of the legs 102 of the case 96. The extension clip 200, and in particular the clip tail piece 204, is then attached to the lips 114 of the retractor 95 in the manner previously described for the bolt tail 132 attachment to the lips 114 for the shorter backset, and the face plate 46 is secured to the edge of the door.

Next, the outside rose plate 32 is slid over the outside end cap 98. As seen in FIG. 2, both end caps 98 have longitudinally-spaced lateral grooves 146 for receiving the rose plates 26, 32. The rose plates 26, 32 are adapted to be engaged in either one of the two grooves 146 in the end caps 98 to accommodate different door thicknesses. The outside rose plate 32 has an oblong central opening 50. The oblong opening 50 has a larger portion of sufficient dimension to allow the rose plate 32 to fit over the outside end cap 98 of the latch housing 90. The oblong central opening 50 also has two opposed flats which define a narrower portion of the oblong central opening 50. This shape of the opening 50 allows the outside rose plate 32 to be assembled eccentrically with respect to the housing 90 with the narrower portion of the oblong central opening 50 centered over the housing 90 and the flats seated in one set of grooves 146. The outside rose plate 32 is thus aligned with the appropriate groove 146 in the end cap 98, the outermost groove for a thick door or the innermost groove for a thin door, and moved laterally to a concentric position with respect to the housing 90. Once the outside rose plate 32 is so engaged, the housing 90 is fixed rotationally and axially with respect to the outside rose plate 32. The outside end cap 98 of the housing 90 also includes opposed longitudinal ribs 148 and the oblong central opening 50 in the outside rose plate 32 includes opposed notches. The notches are adapted to receive the corresponding longitudinal rib 148 when the outside rose plate 32 is engaged in either of the sets of grooves 146 as described above. This configuration further strengthens the assembly against rotation of the outside rose plate 32 with respect to the housing 90.

The outside rose 34 fits against the outside rose plate 32. Openings in the outside rose plate 32 are aligned with threaded holes in the outside rose 34 for use with screws for securing the outside rose plate 32 to the outside rose 34.

The inside rose plate 26 is secured to the inside rose 28 and then moved over the inside end cap 98 and against the door surface. Bolt holes in the inside rose 28 are aligned with threaded bolt holes of the outside rose 34. The threaded ends of the bolts 56 are then passed through the unthreaded holes in the inside rose 28 and into the threaded holes of the outside rose 34. The bolts 56 are then tightened to draw the rose plates 26, 32 and roses 28, 34 to a secure assembled position on opposite sides of the door whereby the heads of the bolts 52 come to rest in countersunk holes in the outer face of the inside rose 28. It is noted that in attaching the roses 28, 34 in the manner described above, protrusions on the sleeves 92, 94 are aligned with corresponding slots (not shown) in the spindles 68, 70 such that the sleeves 92, 94 and spindles 68, 70 rotate together within the lockset assembly 20.

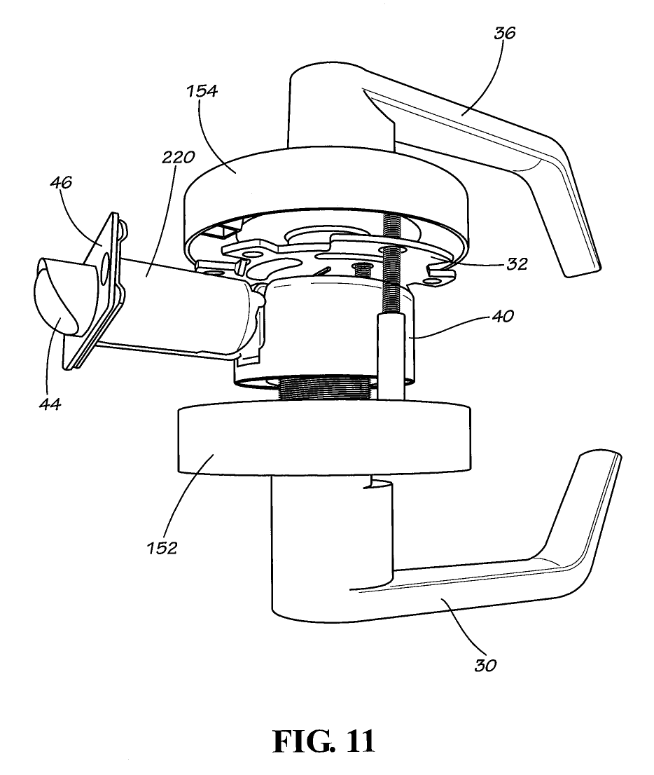

To complete the assembly, an inside rose scalp 152 is slipped over the inside spindle 68 and the inside rose 28 and the inside lever 30 is secured onto the inside spindle 68. Similarly, an outside rose scalp 154 is placed over the outside spindle 70 and the outside rose 34 and the outside lever 36 is secured onto the spindle 70. In attaching the levers 30, 36, the axial hub openings 79, 81 are positioned over the spindles 68, 70, which include a pair of diametrically opposed longitudinal slots 156. The slots 156 receive corresponding ribs formed in the levers 30, 36 to facilitate rotation of the spindles 68, 70 upon actuation of the levers 30, 36. The hub openings 79, 81 are also formed with transverse depressions and are positioned for alignment with transverse slots formed in spindles 68, 70. Spring-biased detents or catch plates (not shown) extend through the slots and into the depressions to retain the levers 30, 36 on the sleeves 92, 94. The assembly 20 is shown in its assembled form in FIG. 11.

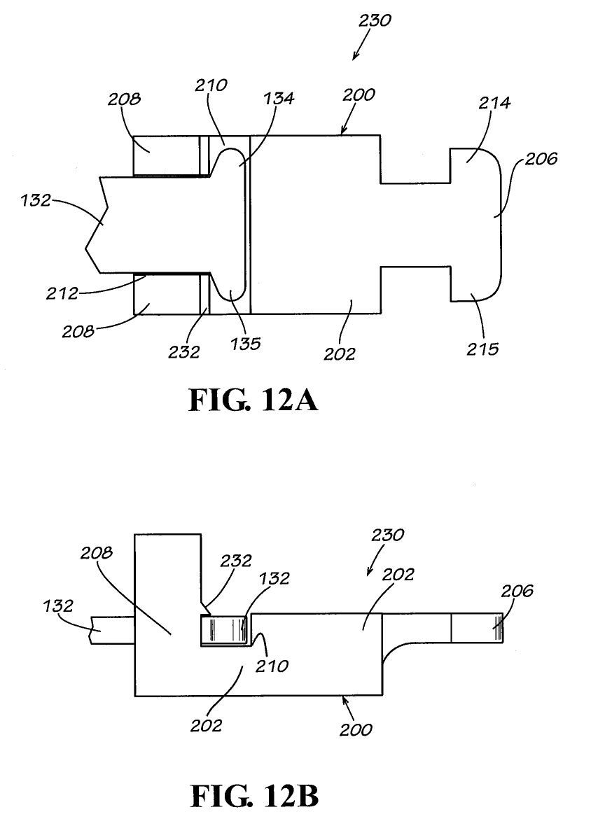

Embodiments of the extension clip for an adjustable backset lockset utilizing different means than magnetic retention are available for mounting the extension clip 202 to the latch assembly 42, and more specifically, to the bolt tail 132. A snap fit 230 is shown in FIGS. 12A and 12B. To provide the snap fit 230, a protrusion 232 is provided along the top edge of the protruding fingers 208, extending inward towards the channel 210. When the bolt tail 132 is inserted into the channel 210, the edges of the arms 134, 135 that are away from the clip tail piece 206 are obstructed by the protrusion 232, and the bolt tail 132 is restrained in the channel 210.

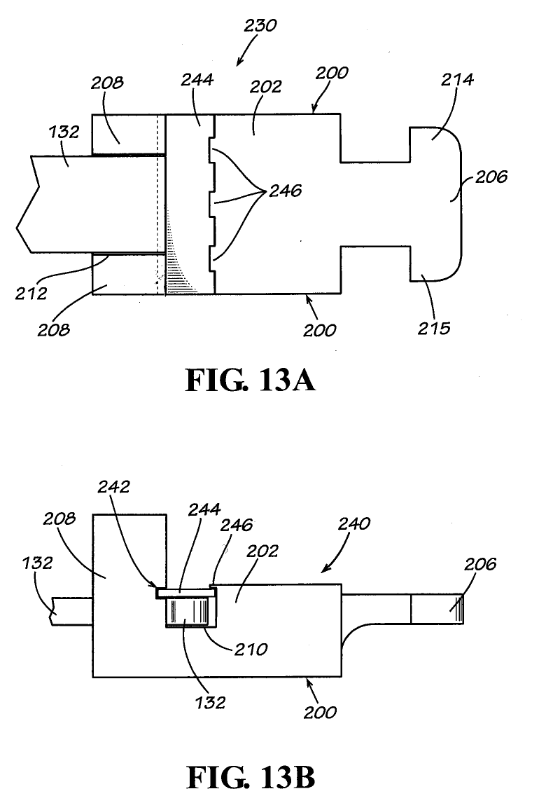

Another embodiment for mounting of the extension clip 202 is with mechanical deformation of the extension clip 202 to provide a mechanically restrained connection 240 as shown in FIGS. 13A and 13B. A slot 242 that opens toward the channel 210 is provided in the fingers 208 at a distance from the bottom of the slot 242 just greater than the thickness of the bolt tail 132. A flat member 244, which may be for example, a thin piece of aluminum, may be inserted into the slot 242 such that it extends the length of the channel 210. On the opposite side of the channel 210 the extension clip 200 may be deformed along the length of the top of the channel 210, or, as shown, the deformation may be periodic by “staking,” and intermittent stakes 246 may be provided for the length of the channel 210. With the member 244 positioned in the slot 242 and beneath the stakes 246, the bolt tail 132 is pinned in place, restrained from moving out of the channel 210.

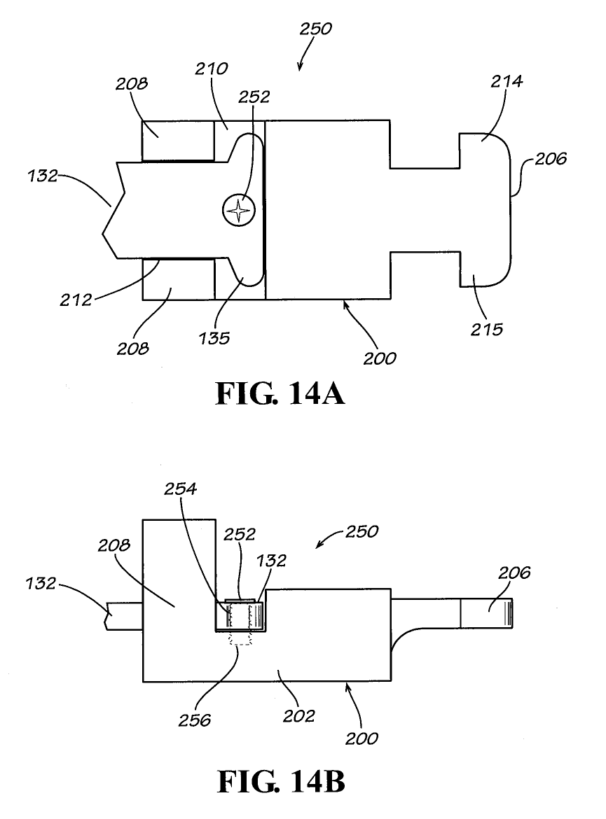

Yet another embodiment for mounting of the extension clip 202 is by use of positively applied force with a threaded connection 250 as shown in FIGS. 14A and 14B. A threaded fastener, such as a Phillips head machine screw 252 is passed through a hole 254 in the bolt tail 132 and is secured in a threaded opening 256 in the bottom of the channel 210 of the extension clip 200.

Although only a few exemplary embodiments have been shown and described in considerable detail herein, it should be understood by those skilled in the art that we do not intend to be limited to such embodiments since various modifications, omissions and additions may be made to the disclosed embodiments without materially departing from the novel teachings and advantages, particularly in light of the foregoing teachings. For example, although a cylindrical lock is shown, the novel extension clip shown and described herein may be used with any type of latchset or lockset for accommodating two or more backset distances. It is envisioned that a variety of extension clips and corresponding sleeves may be made to accommodate a variety of lock assemblies and backset dimensions not discussed in detail herein. Accordingly, we intend to cover all such modifications, omission, additions and equivalents as may be included within the spirit and scope as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A lock assembly, comprising:
a housing;
a latchbolt including an attachment member;
an extension member having a length, the extension member being removeably mountable to the attachment member for effective lengthening of the latchbolt;
a retractor element disposed within the housing for linear reciprocating movement, the retractor element selectively engageable with the attachment member or with the extension member for movement with the retractor element; and
an operator operatively connected to the retractor element for facilitating selective reciprocation of the retractor element for moving the latchbolt between a latched position and an unlatched position.

2. The lock assembly of claim 1, wherein the extension member is mounted to the attachment member and to the retractor element.

3. The lock assembly of claim 2, wherein the latchbolt is effectively lengthened ⅜ inch by the mounting of the extension member.

4. The lock assembly of claim 1, wherein the lock assembly is adapted to accommodate a first backset dimension of a door when the retractor element engages the attachment member and a second backset dimension of the door when the retractor element engages the extension member and the extension member is mounted to the attachment member.

5. The lock assembly of claim 4, wherein the first backset dimension is 2⅜ inches and the second backset dimension is 2¾ inches.

6. The lock assembly of claim 1, further comprising a cylindrical latch case to receive the latchbolt when the retractor element engages the attachment member and a cylindrical sleeve to receive the latch case and the latch bolt when the retractor element engages the extension member.

7. The lock assembly of claim 6, wherein the cylindrical latch case and sleeve both include ears for engaging the retractor element.

8. A lock assembly, comprising:
a housing;
a latchbolt including an attachment member;
means for effective lengthening of the latchbolt, the effective lengthening means being removeably engageable with the attachment member;
means for linear reciprocating movement disposed within the housing, the linear reciprocating movement means selectively engageable in one instance with the attachment member and in another instance with the effective lengthening means for movement with the linear reciprocating movement means; and
means for facilitating selective reciprocation of the retractor element for moving the latchbolt between a latched position and an unlatched position.

9. The lock assembly of claim 8, further comprising a latch case to receive the latchbolt and means for effective lengthening of the latch case.

10. An extension member for a latchbolt of a lock assembly, the latchbolt including an attachment member, the lock assembly including a retractor element for linear reciprocating movement and engageable with the attachment member, the extension member comprising:
a body having a longitudinal axis, a first end, and a second end;
a tail piece mounted to the body and extending from the first end, the tail piece dimensioned so as to function in place of the attachment member when engaging the retractor element;
wherein the body defines a recess adapted to receive the attachment member from the second end and to transfer force to the attachment member during linear movement of the extension member as urged by the retractor element.

11. The extension member of claim 10, wherein the tail piece is substantially a T-shape.

12. The extension member of claim 10, wherein the body comprises a base and two spaced parallel fingers projecting in the same direction from the base proximate to the second end, and wherein the base and the fingers define the recess.

13. The extension member of claim 12, wherein the recess comprises a transverse channel across the base, the transverse channel having two sides and a bottom, and an opening defined between the fingers to substantially form a T-shape.

14. The extension member of claim 13, further comprising a magnet disposed in an opening defined by the base in the bottom of the channel to retain the attachment member in the recess.

15. The extension member of claim 13, wherein a protrusion extends along on one side of the transverse channel adapted to retain the attachment member in the recess.

16. The extension member of claim 13, further comprising a retaining member and wherein the fingers define a slot on one side of the transverse channel in which the retaining member is disposed and on the opposite side of the transverse channel the base is mechanically deformed to restrain the retaining member, and the retaining member, slot, and mechanically deformed areas of the base are adapted to restrain the attachment member in between the retaining member and the bottom of the transverse channel.

17. The extension member of claim 13, further comprising a threaded fastener, wherein the base defines a threaded opening in the bottom of the transverse channel to receive the threaded fastener, and wherein the threaded fastener is adapted to pass through a hole in the attachment member.

18. A latchbolt assembly comprising:
a latchbolt including a bolt tail; and
an extension member, the extension member removeably mountable to the bolt tail for effectively lengthening the latchbolt.

19. The latchbolt assembly of claim 18, further comprising a cylindrical latch case to receive the latchbolt and a cylindrical sleeve to receive latch case and latch bolt.

20. A method of adjusting the backset distance of a lock assembly, the method comprising:
providing a lock assembly having a housing, a latchbolt including an attachment member, a retractor element disposed within the housing for linear reciprocating movement, and an operator operatively connected to the retractor element for facilitating selective reciprocation of the retractor element for moving the latchbolt between a latched position and an unlatched position;
providing an extension member sized and shaped to be engageable with the attachment member and with the retractor element;
securing the extension member to the attachment member; and
engaging the extension member with the retractor element for movement with the retractor element.

21. The method of claim 20, further comprising passing a latch case over the latchbolt and passing a sleeve over the latchbolt and extension member.

22. The method of claim 20, wherein securing the extension member to the attachment member is performed with a magnet embedded in the extension member.

23. The method of claim 20, wherein securing the extension member to the attachment member is performed by disposing the attachment member in a recess in the extension member and physically blocking removal of the attachment member with a protrusion over the recess.

24. The method of claim 20, wherein securing the extension member to the attachment member is performed by providing a retaining member over a recess in the extension member that receives the attachment member, and disposing the retaining member in a slot on one side of the recess and mechanically deforming the extension member on another side of the recess to restrain the retaining member.

25. The method of claim 20, wherein securing the extension member to the attachment member is performed by passing a threaded fastener through a hole in the attachment member and screwing the threaded fastener into a threaded opening in the extension member.
